(19) United States
(12) Patent Application Publication
(10) Pub. No.: US 2017/0021807 A1
(43) Pub. Date: Jan. 26, 2017

(54) OUTPUT ELEMENT, MOTORISATION DEVICE FOR DRIVING AT LEAST ONE WINDSCREEN WIPER ARM OF A MOTOR VEHICLE, AND METHOD FOR PRODUCTION OF AN OUTPUT ELEMENT

(71) Applicant: Valeo Systèmes d'Essuyage, Le Mesnil Saint Denis (FR)

(72) Inventor: Christophe Lassalle, Leigne Les Bois (FR)

(73) Assignee: Valeo Systèmes d'Essuyage, Le Mesnil Saint Denis (FR)

(21) Appl. No.: 15/217,453

(22) Filed: Jul. 22, 2016

(30) Foreign Application Priority Data
Jul. 24, 2015 (FR) 1557119

(51) Int. Cl. B60S 1/26; F16H 55/22; F16H 55/06; B60S 1/08

(52) U.S. Cl. CPC B60S 1/26; B60S 1/08; F16H 55/22; F16H 55/06; F16H 2055/065

(57) ABSTRACT

The invention concerns an output element (15; 151) for a motorisation device (1) for driving at least one windscreen wiper arm of a motor vehicle, comprising an output shaft (17; 171) and a toothed wheel (40) integral to and coaxial with the output shaft (17; 171), characterized in that the output shaft (17; 171) is made of plastic material and in that the output element (15; 151) comprises a metallic insert (16; 161; 162; 163), the plastic material of the output shaft (17; 171) being moulded partially over the metallic insert (16; 161; 162; 163), revealing an insert head (25; 251) protruding from the end of the output shaft (17; 171) and intended to connect to a windscreen wiper element in order to drive this in rotation.

The invention also concerns a motorisation device (1) and a method for production of an output element (15; 151).

The present invention concerns an output element for a motorisation device, and a motorisation device for driving at least one windscreen wiper arm of a motor vehicle. The invention also concerns a method for production of an output element for a motorisation device.

Certain motorisation devices for driving windscreen wiper arms comprise a leading shaft driven by a motor with an endless screw engaging with a toothed wheel integral with a trailing shaft.

The toothed wheel is mounted on a first end of the trailing shaft made of steel. The second end of the trailing shaft generally carries either a crank, for example press-fitted then snap-locked, or a wiper blade drive unit.

One of the aims of the present invention is to propose an alternative to the known motorisation devices for driving at least one windscreen wiper arm of a motor vehicle.

To this end, the object of the invention is an output element for a motorisation device for driving at least one windscreen wiper arm of a motor vehicle, comprising an output shaft and a toothed wheel integral to and coaxial with the output shaft, characterized in that the output shaft is made of plastic material and in that the output element comprises a metallic insert, the plastic material of the output shaft being partially moulded over the metallic insert, revealing an insert head protruding from the end of the output shaft and intended to connect to a windscreen wiper element in order to drive this in rotation.

Making the output shaft from plastic material significantly reduces the weight of the motorisation device, this weight reduction being up to around 50% of the total weight, without increasing the costs of production of this device.

Also, the metallic insert opening at the end of the output shaft allows the retention of a metal-to-metal cooperation at the drive output of the motorisation device. This metallic cooperation may prove essential in particular for forced mounting of a crank with an opening of small dimensions, such as of the order of 10 mm.

Also, the output shaft may easily be adapted to cooperate with different complementary forms of the element of the wiper arm to be driven in rotation. For this, during the production process, it is sufficient to modify the shape of the insert head before the metallic insert is over-moulded with the plastic material of the output shaft. In this way, a windscreen wiper element, such as a crank or a windscreen wiper arm, may be assembled using the same production method as that already existing.

According to one or more characteristics of the output element taken alone or in combination:
an inner portion of the metallic insert over which the plastic material of the output shaft is moulded has peripheral radial reliefs and hollows,
the peripheral radial reliefs and hollows of the inner portion are formed by axial splines,
the peripheral radial reliefs and hollows of the inner portion are formed by at least two radial lobes,
the metallic insert is made of two separate parts joined together axially, a first part carrying the insert head and a second part carrying the inner portion,
the plastic material of the output shaft comprises a plastic matrix and reinforcing fibres,
the toothed wheel is made of plastic material and the plastic material of the toothed wheel is different from the plastic material of the output shaft; this allows optimisation of the mechanical strength of the output element while limiting its cost and the weight of the motorisation device,
the toothed wheel is made of plastic material and the plastic material of the toothed wheel is moulded over the output shaft,
the output shaft has a radial base over which the plastic material of the toothed wheel is moulded,
the radial base comprises at least one axial hole and/or peripheral radial reliefs and hollows. Thus during over-moulding, the plastic material of the toothed wheel becomes engaged in the holes of the radial base, reinforcing the mutual support of the toothed wheel with the output shaft. This allows the transmission of torque from the electric motor to the element to be driven in rotation, including a torque of great amplitude.
the output shaft is hollow and opens at the end opposite the end partially receiving the metallic insert. The hollow, open-ended output shaft allows passage of a counterhold tool used against the end of the metallic insert during installation of the motorisation device.
the insert head has a cylindrical form with straight knurling,
the insert head has a fluted frustoconical portion on which a threaded cylindrical portion is arranged.

The invention also concerns a motorisation device for driving at least one windscreen wiper arm of a motor vehicle, characterized in that it comprises an output element as described above.

The invention also concerns a method for production of an output element as described above, characterized in that it comprises a step during which a plastic material is moulded over an inner portion of a metallic insert in order to form at least one output shaft.

The production method may comprise a step during which a plastic material is moulded over the output shaft in order to form a toothed wheel.

According to a characteristic of the invention, the plastic materials of the output shaft and of the toothed wheel may be co-injected.

### BRIEF DESCRIPTION OF THE DRAWINGS

Further advantages and characteristics will appear from reading the description of a non-limitative exemplary embodiment of the invention and from the attached drawings on which:

FIG. 1 shows a diagrammatic view of elements of a motorisation device,

FIG. 2 shows a perspective view of a first embodiment of an output element of the motorisation device in FIG. 1, said output element comprising in particular an insert and an output shaft joined together,

FIG. 3 shows a perspective view of a first variant of the output shaft, the body of which is shown transparently, of the output element of FIG. 2,

FIG. 4 shows a perspective view of a first variant of a metallic insert, configured to cooperate with the first variant of the output shaft of FIG. 3 to form the output element of FIG. 2,

FIG. 5 shows a perspective view of a second variant of the output shaft, the body of which is shown transparently, of the output element of FIG. 2,

FIG. 6 shows a perspective view of a second variant of a metallic insert, configured to cooperate with the second variant of the output shaft of FIG. 5 to form the output element of FIG. 2,

FIG. 7a shows a first part of the metallic insert of FIG. 6,

FIG. 7b shows a second part of the metallic insert of FIG. 6,

FIG. 8 shows a perspective view of a second embodiment of an output element,

FIG. 9 shows a perspective view of a metallic insert according to a third variant, configured to be fitted to the output element according to the second embodiment, and

FIG. 10 shows a perspective view of a metallic insert according to a fourth variant, configured to be fitted to the output element according to the second embodiment.

On the figures, identical or similar elements carry the same reference numerals.

The following embodiments are exemplary. Although the description refers to one or more embodiments, this does not necessarily mean that each reference concerns the same embodiment, or that the characteristics apply merely to a single embodiment. Individual characteristics of the various embodiments may also be combined to produce other embodiments.

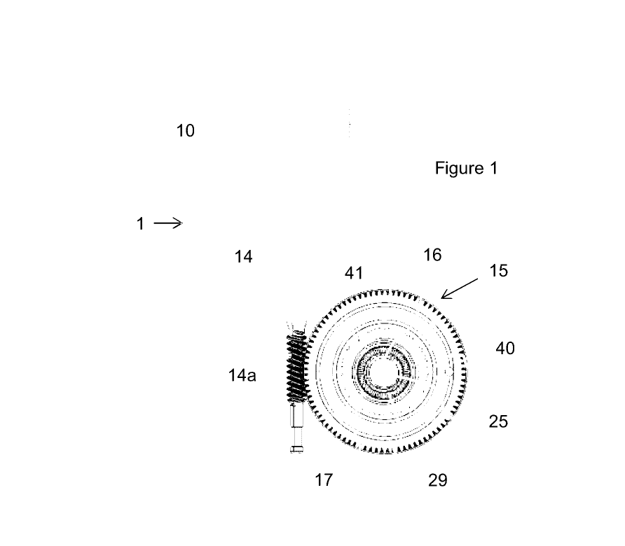

With reference to FIG. 1, we see a motorisation device 1 for driving at least one windscreen wiper arm of a motor vehicle, such as for driving the wiper arms on the driver's and passenger's side of the windscreen.

The motorisation device 1 comprises an electric drive motor 10 housed in a casing (not shown). The motor 10 conventionally comprises a stator and a rotor, the leading shaft 14 of which, protruding from the rotor, carries an endless screw 14a.

The motorisation device 1 also comprises an output element 15 comprising an output shaft 17 fixed in rotation with a toothed wheel 40, the output toothing 41 of which meshes with the endless screw 14a.

According to another embodiment (not shown), the motorisation device 1 comprises rotating transfer elements of a gear transmission between this leading shaft 14 and the output element 15, for example generating a mechanical reduction.

The output shaft 17 is made of plastic material.

The output element 15 also comprises a metallic insert 16 arranged at the axial end of the output shaft opposite the toothed wheel.

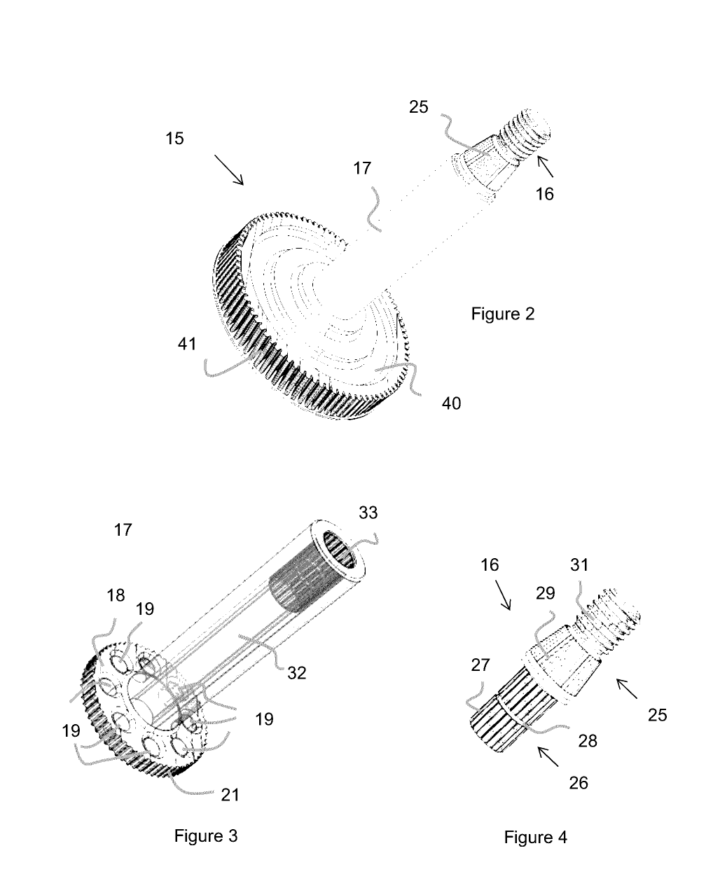

As can be better seen from FIG. 2, the plastic material of the output shaft 17 is partially moulded over the metallic insert 16, revealing an insert head 25. The insert head 25, protruding from the output shaft 17, is intended to be connected to a wiper element to be driven in rotation, such as a crank (or lever) of a transmission device of a wiper mechanism or such as a head of a wiper arm (not shown).

Making the output shaft 17 of plastic material allows a significant reduction in the weight of the motorisation device 1 without increasing its cost. Also, the metallic insert 16 opening at the end of the output shaft 17 allows retention of a metal-to-metal cooperation at the drive output of the motorisation device 1. This metallic cooperation may prove essential in particular for force-mounting of a crank with an opening of small dimensions, such as of the order of 10 mm. Also, the output element 15 may easily be adapted to cooperate with different complementary forms of the element of the wiper arm to be driven in rotation. For this, during the production process, it is sufficient to modify the shape of the insert head 25 before over-moulding the metallic insert 16 with the plastic material of the output shaft 17. Thus a windscreen wiper element such as a crank or a wiper arm can be assembled using the same mounting procedure as that already existing.

The plastic material of the output shaft 17 may comprise one or more different plastics. The plastic material may comprise a plastic matrix reinforced with reinforcing fibres, such as non-metallic fibres, such as carbon, glass or aramide fibres. In this way, the rigidity and strength of the output shaft 17 are increased.

With the aim of reducing the weight of the device, the toothed wheel 40 may also be made of plastic material.

Then the toothed shaft formed by the toothed wheel 40 and the output shaft 17 may be made as a single part formed from a same plastic material, or—as has been described above—from several different plastics or from a fibre-reinforced plastic matrix.

Alternatively, it may be provided that the plastic material of the toothed wheel 40 is moulded over the output shaft 17.

For this, during the process of production of the output element 15, the toothed shaft is formed by moulding a plastic material over the output shaft 17 in order to form a toothed wheel 40. This over-moulding may be performed either using the output shaft as an insert or, if the different injection temperatures of the plastic materials allow, by co-injection of the plastic materials of the output shaft 17 and the toothed wheel 40.

The material of the toothed wheel 40 may comprise one or more different plastics which may be of different types from the plastic material or materials of the output shaft 17.

For example, a toothed wheel 40 is provided in polyoxymethylene or POM. This plastic material has good qualities of flexibility and a good coefficient of friction.

The over-moulding of the plastic material of the toothed wheel 40 over the output shaft 17 allows different characteristics to be given for the toothed wheel 40 and the output shaft 17, which allows optimisation of the mechanical strength of the output element 15 while limiting its cost and the weight of the motorisation device 1.

Thus for example, the toothed shaft may be more rigid at the output shaft 17 than at the toothed wheel 40.

The toothed wheel 40 may have a certain flexibility in order to engage with the metallic endless screw 14a of the motorisation device 1. However the output shaft 17 may have a greater strength in order to resist the meteorological stresses, in particular in relation to the salinity or humidity of the atmosphere.

Also, the output shaft 17 may have a radial base 18 over which the plastic material of the toothed wheel 40 is moulded.

The radial base 18 is generally disc-shaped (FIGS. 3 and 5) and is completely over-moulded by the plastic material of the toothed wheel 40 (FIG. 2).

The diameter of the radial base 18 lies for example between ⅓ and ⅔ of the diameter of the toothed wheel 40, such as of the order of half the diameter of the toothed wheel 40. The thickness of the radial base 18 lies for example between ⅓ and ⅔ of the thickness of the toothed wheel 40, such as of the order of half the thickness of the toothed wheel 40.

The radial base 18 may also comprise one or more axial holes 19, for example eight holes 19, which may be regularly distributed in the radial base 18 around the axis of the output shaft 17. Thus during the over-moulding, the plastic material of the toothed wheel 40 becomes engaged in the holes 19 of the radial base 18, reinforcing the mutual connection of the toothed wheel 40 with the output shaft 17. This allows the transmission of torque from the electric motor 10 to the element to be driven in rotation, including torques of great amplitude.

The radial base 18 may also comprise peripheral radial reliefs and hollows such as a fluted surface 21, formed by successive, peripheral and parallel splines. The peripheral shapes also allow better adhesion of the plastic material of the toothed wheel 40 on the output shaft 17 during the over-moulding.

The metallic insert 16 comprises the insert head 25 and an inner portion 26 which are arranged in the extension of each other and aligned on the same axis. The insert portion 25 and the inner portion 26 have a same length in this example.

The metallic insert 16 may be made of one piece or of two pieces joined together.

As described above, the insert head 25 is configured to cooperate with drive means associated with the wiper blades. The inner portion 26 is housed inside the output shaft to ensure the firm fixing of the insert 16 with the toothed shaft.

The inner portion 26 of the metallic insert 16, over which the plastic material of output shaft 17 is moulded, has peripheral radial reliefs and hollows. The radial peripheral shapes of the inner portion 26 thus allow better adhesion of the plastic material of the output shaft 17 when it is moulded over the metallic insert 16. It ensures the cohesion of the assembly, allowing the transmission of torque from the electric motor 10 to the element to be driven in rotation.

A first variant embodiment of the metallic insert is illustrated on FIGS. 3 and 4.

The peripheral radial reliefs and hollows of the inner portion 26 are formed by peripheral axial splines 27 which are substantially mutually parallel. The inner portion 26 then has a generally cylindrical form with straight knurling.

The inner portion 26 may also have at least one annular groove 28, for example arranged in the middle of the axial splines 27.

The insert head 25 has a fluted frustoconical portion 29 on which a threaded cylindrical portion 31 is arranged. The frustoconical portion 29 is intended to cooperate with a complementary cavity of a head of a wiper arm or crank. A nut is then clamped onto the threaded cylindrical portion 31.

The output shaft 17 has a hollow form opening at least at the axial end 33 partially receiving the metallic insert 16, so as to form a housing for the inner portion 26. This housing has shapes and reliefs corresponding to the peripheral shapes and reliefs of the inner portion. When the output shaft is moulded over the insert, this housing is created around the inner portion 26. Material becomes deposited in the annular groove 28 and reinforces the engagement of the output shaft around the insert.

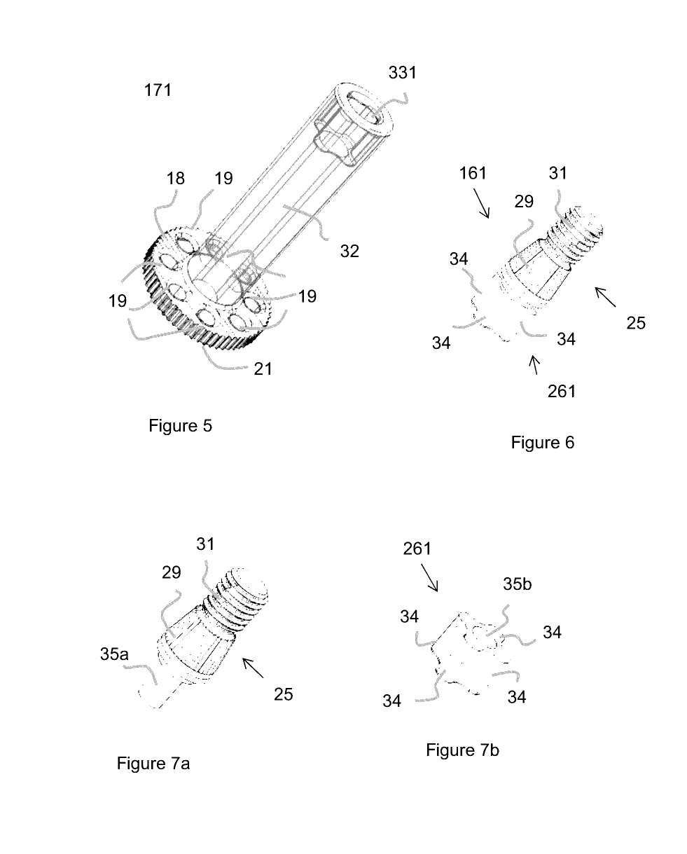

FIGS. 5, 6, 7a and 7b illustrate a second variant embodiment of the insert and the output shaft.

The inner portion 261 has peripheral radial reliefs and hollows formed by at least two radial bosses 34, for example four regularly spaced around the periphery of the inner portion 261 and extending axially.

Other radial peripheral shapes (not shown) which allow the adhesion of the over-moulded plastic material may of course be used for the inner portion. For example, the inner portion has a cross-section in the shape of a six-point star of the TORX® type.

Also, in this example, the metallic insert 161 is made of separate parts joined together axially. A first part (FIG. 7a) carries the insert head 25 and a second part (FIG. 7b) carries the inner portion 261.

The first and second parts may have complementary joining means 35a, 35b such as a stud 35a and a complementary hole 35b extending axially and allowing mutual positioning. It may be provided that the stud has an external thread and the complementary hole has an internal thread for example.

From the production point of view, a two-part metallic insert 161 allows an inner portion 261 common to the different types of metallic insert. To adapt the motorisation device 1, it is then sufficient simply to change the insert head 25. Thus production of the toothed shaft and inner portion of the insert can be standardised, which reduces production costs.

It is noted that, in this second embodiment variant, the metallic insert 161 has an inner portion 261 which is for example shorter than the insert head 25.

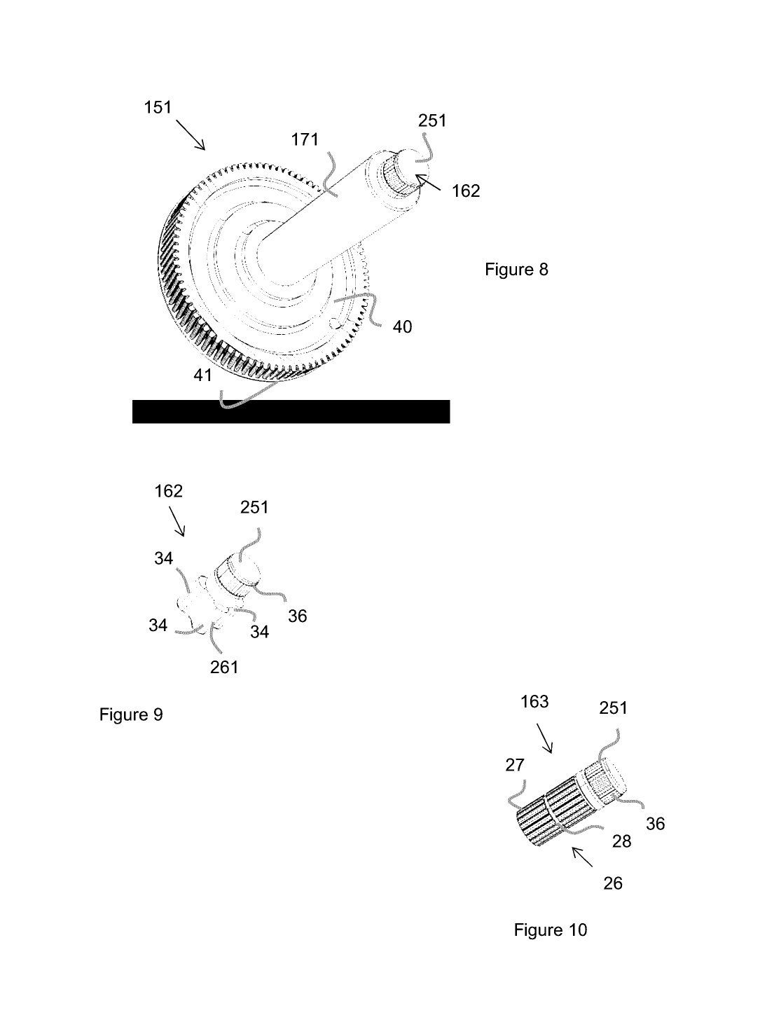

A second embodiment of the output element illustrated on FIGS. 8 to 10 differs from the embodiment previously described in that the insert head 251 is different.

The insert head 251 has a generally cylindrical form with straight knurling, with peripheral axial grooves and ribs 36 which are substantially mutually parallel. The cylindrical form with straight knurling is intended to be inserted in a complementary hole of the head of the arm or crank of a transmission device of a wiper mechanism. The crank or arm may thus be press-fitted and then snap-locked onto the insert head 251.

Here again, at least two variant embodiments of the insert may be provided. A third variant, illustrated on FIG. 9, has an inner portion 261 similar to the inner portion of the second variant of the insert described above, and the insert head 251 of generally cylindrical form with straight knurling. In a fourth variant illustrated on FIG. 10, the metallic insert 163 has the same insert head 251 of generally cylindrical form with straight knurling, and an inner portion 26 with a generally cylindrical form with straight knurling with at least one annular groove 28 as described in the first embodiment variant.

As described above, the output shaft 17 is hollow at least over the part receiving the inner portion of the metallic insert. It may be provided, as illustrated, that the output shaft is hollow over the entire length of the output shaft so as to present a housing 32 which opens at the radial base 18 via an outlet orifice. Such an output shaft 17, hollow over its entire length, allows the passage of a counterhold tool used against the end of the metallic insert 16 during installation of the motorisation device 1.

In the description above, the output shaft is moulded over the inner portion of the insert, and the toothed wheel is moulded over the output shaft. It will be understood that in the process of obtaining the output element according to the invention, it is possible also to perform the step of over-moulding the output shaft by the material of the toothed wheel after or before the step of over-moulding the insert by the material of the output shaft, such that without leaving the context of the invention, it is possible to over-mould the toothed wheel onto an assembly formed from the output shaft and the insert, or to over-mould the toothed shaft as a whole, i.e. the toothed wheel and the output shaft, onto the inner portion of the insert.

1. An output element for a motorization device for driving at least one windscreen wiper arm of a motor vehicle, comprising:
an output shaft; and
a toothed wheel integral to and coaxial with the output shaft,
wherein the output shaft is made of plastic material and the output element comprises a metallic insert, the plastic material of the output shaft being moulded partially over the metallic insert, revealing an insert head protruding from the end of the output shaft and intended to connect to a windscreen wiper element in order to drive this in rotation.

2. The output element according to claim 1, wherein the metallic insert comprises said insert head and an inner portion over which the plastic material of the output shaft is moulded.

3. The output element according to claim 2, wherein said inner portion has peripheral radial reliefs and hollows.

4. The output element according to claim 3, wherein the peripheral radial reliefs and hollows of the inner portion are formed by axial splines.

5. The output element according to claim 3, wherein the peripheral radial reliefs and hollows of the inner portion are formed by at least two radial bosses.

6. The output element according to claim 2, wherein the metallic insert is made of two separate parts joined together axially, a first part carrying the insert head and a second part carrying the inner portion.

7. The output element according to claim 1, wherein the plastic material of the output shaft comprises a plastic matrix and reinforcing fibres.

8. The output element according to claim 1, wherein the toothed wheel is made of plastic material and in that the plastic material of the toothed wheel is different from the plastic material of the output shaft.

9. The output element according to claim 1, wherein the toothed wheel is made of plastic material and in that the plastic material of the toothed wheel is moulded over the output shaft.

10. The output element according to claim 9, wherein the output shaft has a radial base over which the plastic material of the toothed wheel is moulded.

11. The output element according to claim 10, wherein the radial base comprises at least one axial hole and/or peripheral radial reliefs and hollows.

12. The output element according to claim 1, wherein the output shaft is hollow and opens at the end opposite the end partially receiving the metallic insert.

13. The output element according to claim 1, wherein the insert head has a cylindrical form with straight knurling.

14. The output element according to claim 1, wherein the insert head has a fluted frustoconical portion on which a threaded cylindrical portion is arranged.

15. A motorization device for driving at least one windscreen wiper arm of a motor vehicle, comprising an output element according to claim 1.

16. A method for production of an output element according to claim 1, comprising a step during which a plastic material is moulded over an inner portion of a metallic insert in order to form at least one output shaft.

17. The method according to claim 16, further comprising a step during which a plastic material is moulded over the output shaft to form a toothed wheel.

18. The method according to claim 17, wherein the plastic materials of the output shaft and of the toothed wheel are co-injected.
